(19) United States
(12) Patent Application Publication
(10) Pub. No.: US 2005/0198690 A1
(43) Pub. Date: Sep. 8, 2005

(54) Method and apparatus for capturing content and creating multimedia presentations

(76) Inventors: Gary Esolen, New Orleans, LA (US); Ken Hays, Metairie, LA (US)

Correspondence Address: Gary Esolen, Apt. No. 1, 317 Royal Street, New Orleans, LA, 70130, US

(21) Appl. No.: 10/986,443

(22) Filed: Nov. 12, 2004

Related U.S. Application Data
(60) Provisional application No. 60/518,679, filed on Nov. 12, 2003.

(51) Int. Cl. H04N 7/16; H04N 7/173

(52) U.S. Cl. 725/145; 725/115; 725/116

(57) ABSTRACT

A method and apparatus for generating a variety of programming by the computer-automated combining of pre-recorded segments organized around topics and themes and identified as to length and function, into sequences which may include paid advertising appropriately inserted according to context and time or sequence of delivery. A variety of media clips may be used and combined in a plurality of context and time sequences to provide a program that continuously fresh and relevant content.

### REFERENCE TO RELATED APPLICATION

The present application claims priority to provisional application Ser. No. 60/518,679 filed Nov. 12, 2003 and entitled“Method And Apparatus For Capturing Content And Creating A Multimedia Presentation”

### BACKGROUND OF THE INVENTION

The present invention is related to the field of multimedia creation, capturing, compilation and distribution, and more particularly is directed to a method and apparatus for capturing content and creating a multimedia presentation.

The difficulty and expense of creating varied and fresh content in media programs is a major limitation for companies whose success and revenues depend on pleasing audiences with programming delivered through broadcast, cable, satellite, fiber, or other means. The most common solution to the problem is to pre-record sizable segments of programming and deliver it more than once, as a series of news and feature items might be repeated on a cable television news, financial, or sports channel. Another common solution is to combine pre-recorded elements with on-air talent and engineering capability to set context, create transitions, and vary content appropriately. Often such large-scale pre-recorded segments, or segments customized with on-air talent and engineering capability, are intermixed with paid advertising content, sometimes with automated insertion.

Accordingly, there is a need in the art for a more effective method and apparatus for creating varied and fresh content in medial programs.

### SUMMARY OF THE PRESENT INVENTION

The present invention represents the juncture of tourism and media and involves a television station in each market, with material captured in high-definition and broadcast (or conceivably fiber-delivered) to hotels and other tourism locations. The material is either received in native high definition or down converted to standard definition and delivered to sets for viewing. Along with that station, which may be supported by advertising, travel services for the sale of high-end mementos (upscale souvenirs) of the place being visited can be provided. The mementos and tours can be sold “shopping channel” style on the station. The service will also include the creation of a 30 to 45 minute long “soul of place” film acquired, edited, and delivered in high definition by digital projection for paid admission in a theatre in each city in which is has a television station.

The apparatus and method of the present invention also includes the creation of a web site and a radio show and further include a substantial library of high-definition images of places and locations. Such images can be offered for licensed use in films and commercials.

The present invention may also be used to create syndicated able travel television programming and even a cable or satellite delivered destination channel.

A methodology for understanding and capturing in words and images the deep character of places underlines the present invention. The inventions includes gathering (using specific methods to find writers and specific language to assign tasks) stories revealing the character of the place, analyzing that characters and then capturing images that convey that character. The methodology is replicable and cost-effective.

The present invention will thus allow tours of a location or place in which each experience is an encounter with a person who embodies the living culture of the place—a cultural exemplar. The encounters will take place in settings that reflect the cultural role of the exemplar—such as practice studio for a musician.

The present invention further includes the development of a novel format for television programming. These stations will use almost all locally produced programming, and will broadcast around the clock; which involve a lot of programming. But the audience will be constantly changing. Existing tourism channels solve this problem by simply repeating programming over and over. The present invention relies on a different approach. In accordance with the present invention, programming will consist of many very short (less than one minute to several minutes long) segments or mini-stories, which will be combined over and over in varying sequences and combination. Thus a relatively small amount of programming (for example, 21 hours worth) can be combined and recombined in fresh mixes so that even a viewer in town for a week and watching the station heavily would be unlikely to recognize anything as repeated.

The present invention can also be used to generate a simulated live radio show. This can be accomplished, for example, by recording thousands of songs, recording the names of those songs and the artists, recording intros (“you are about to hear”, etc) and outros (“that was. . .”, “you have been listening to”, etc.) Also recorded are connectives (“and”, “as well as”) and hundreds of “vignettes,” little stories about the particular location, its musicians and its culture, for example. Introductions to a day (“This is Monday and on Monday we are playing traditional jazz all day.”) and to types of music (“Today is gospel music day, and you know “New Orleans” is one of the great homes of gospel. . .”) are also recorded. A computer program is then used which relies on rules of combination to assemble from these pieces a radio show that sounds as if it were a disc jockey talking a spinning records.

A similar method can be used to create a television program. The mini-stories, for example, along with advertising, is assembled by a computer into programming sequences. Everything will be in digital form, stored on a computer or other electronic storage. The computer will assemble a day's worth of programming, which can be stored on a server and delivered from the server to the broadcast signal. Prior to the present invention, there existed no system to generate an entire programming sequence on a computer form stored materials. The present invention also includes a database to categorize “stories” by multiple tags to allow flexible combinations.

Most televisions now is shot for a specific use—a cameraman goes out on a story, gets some images, reviews them., edits them into a sequence, and throws the raw materials away (de-gausses and reuses the tapes). Some material is kept as “library” footage, usually what television stations call B-roll. B-roll footage is “logged,” that is marked with its exact starting point (tape number, hour, minute, second, frame) and ending point. It is often tagged with a brief description. But that description is not kept where it can be computer searched. The process of logging tape takes longer than shooting it, requires high skills, and is so painful that it rarely happens and when it does, it is minimally useful.

In accordance with one aspect of the present invention, in and out points for sequence can be taken straight from the camera in real time as the shooting happens; a grip with a laptop can mark the sequence by subject and key words (including director's comments) and make that searchable. Every “keeper” shot is then available in searchable library.

The present invention creates video and/or audio programming from video and/or audio recorded material by using some or all of the following:
Creating discrete short edited video and/or audio segments in electronic files;
Tagging each video and/or audio segment with one or more category descriptors identifying it as to what kind of content it is;
Tagging each video and/or audio programming or advertising segment with one or more content descriptors on the basis of which that video and/or audio programming segment can be variously combined with other video and/or audio programming segments;
Tagging each video and/or audio programming or advertising segment with one or more function descriptors on the basis of which that video and/or audio programming or advertising segment can be variously combined with other;
Tagging each video and/or audio programming or advertising segment with a description of its length in minute, second, and/or video frames;
Copying and combining these video and/or audio programming or advertising segments in sequences and thereby assembling video and/or audio programming or advertising sequences;
and following rules of combination based on category, content and function descriptors, and length.

Thus, video and/or audio programming or advertising sequence with the desired categories of content, content descriptors and of the desired length can be created manually or automatically. The assembled video and/or audio programming or advertising sequences or combine video and audio programming and advertising sequences can be stored electronically or delivered automatically to broadcast television or radio, cable, satellite internet, DVD, tape, telephony whether wire line or wireless, digital or analog, or any other system.

### BRIEF SUMMARY OF THE DRAWINGS

The present invention will be described in detail with reference to the following figures in which:

FIGS. 1 through 7 illustrate how media clips are combined into to a program in accordance with the present invention.

### DESCRIPTION OF THE PREFERRED EMBODIMENT

The present invention makes it possible to generate a variety of programming by the computer-automated combining of pre-recorded segments organized around topics and themes and identified as to length and function, into sequences which may include paid advertising appropriately inserted according to context and time or sequence of delivery.

One example of the method of the present invention is the creation of computer generated programming for a simulated live radio show in the familiar format of one or more announcers or disc jockeys apparently introducing, playing, and talking about recorded music, performing artists, and other related topics. The method consists of storing on a digital platform, a number of pre-recorded songs, and also pre-recording in the desired voice of an announcer or disc jockey, and storing, the names of songs, performers, record companies, and other information of the kind typically announced on a music program. Also recorded and stored might be language indicating the introduction of a song, such as “you are about to hear” or “now we''ll play.” Also recorded and stored might be language referring back in time, such as “you just heard” or “we have been listening to.” Also recorded might be conjunctions such as “and” or “as well as.” Also recorded might be longer segments consisting of anecdotes, dialogue among announcers or between announcers and guests, or material voiced by others. Also recorded might be introductions to a program, a type of music, a day of programming, or other categories. Also recorded might be paid advertising segments.

Each pre-recorded segment is stored in a digital medium and identified by a unique identifier which would link it to a database, where it would be identified by medium and length, and associated with identifiers for such things as type of music, themes, function, its link to other segments, any limitations as to appropriate context, time sequence, or time of delivery (including such indicators as start and expiration times before of after which a segment would not be used), and other information useful in assembling programming sequences. A goal-seeking engine or other computer program would assemble a sequence of programming following appropriate rules of sequence. The assembled programming, of a desired length and subject, would in turn be delivered immediately to a system of distribution or stored on a digital or analog platform for subsequent delivery.

It is important to understand the formulaic elements from which a type of programming can be composed, and how they combine to produce programming. Music radio shows using an announcer or disc jockey often repeat a limited number of songs in different programs, and such announcers and disc jockeys may (over the course of multiple programs intended to be separated by days, weeks or months) repeat anecdotes and other content without fear of apparent repetition. Yet despite this formulaic nature of the programming, the expense of on-air and engineering talent can be substantial and prohibitive. This method of the present invention addresses that problem.

In a media world in which the channels of delivery are proliferating, the demand for fresh content will be almost insatiable. Digital radio, for instance, offers the prospect of hundreds of different stations, each requiring programming. This method of the resent invention addresses critically important limitations which stand in the way of the efficient generation of such programming.

A second example of the present invention is the creation of documentary-style video programming. Much documentary style video programming is linear in sequence and involves frequent voiceover or other announcer narration which severely limits the degree to which elements can be recombined. For instance, elements might have to be presented in a particular order, and assembling programming in which a segment later in the order preceded one earlier in the order might be inappropriate.

However, by designing documentary style programming from segments which, when organized around themes and topics, tell the story without the intervention of a narrative voice, and using the method described, it becomes possible to generate a variety of programming from limited materials.

Most short media segments might be associated with a multiplicity of topics or themes. A brief “talking head” video segment of an Italian chef in his kitchen, cooking a holiday dish and talking, might suitably appear combined with other elements related to ethnic culture, to Italian culture, to the culinary arts, to holidays, to celebrations, and perhaps to a number of other topics or themes. Using this rich ambiguity, such an element might be used numerous times in contexts sufficiently different as to leave a viewer with little awareness of repetition. Again, this method utilizes the formulaic structure of a genre of programming to permit its computer automated generation from pre-recorded materials.

Such programming might be created for presentation on a television station delivered to visitors to a city or other place, in hotel rooms, at airports, at convention centers, or in other appropriate public or private places. If such a station were to deliver programming continuously, 24 hours a day, 365 days a year, a lot of programming would be required. Where such stations exist a common solution is to pre-record large segments (fifteen minutes or more) and deliver them more than once, indeed as many times as necessary to fill the available time with the available programming. Even if a full 24 hours of programming were available, a visitor exposed to the station for more than one day encounters repeated programming segments, reducing the inventive to view and the desirability of programming to advertisers. This method addresses that problem.

Using the present method of the invention, pre-recorded segments as short as a few seconds or as long as desired can be created, stored on a digital platform, identified by a unique identifier, linked to a database where each can be identified as described above, and those segments can be assembled in the manner described above into programming sequences. An amount of pre-recorded programming inadequate to provide variety using prior art (for example, 24 hours) can be used to generate hundreds of hours of non-repetitive programming, because segments will not appear in the same context, creating more variety than exists in the repetition of larger programming sequences. Again, paid advertising segments can be included in the assembled sequences, with appropriate placement.

As will be understood by one of ordinary skill in the art, many of the tools and components used in this method are readily available in the prior art, including digital storage platforms, computer databases, goal-seeking engines and other computer programs capable of associating elements linked in a database. However, none of these tools have been combined in the novel and unobvious matter as taught by the present invention.

When prior art resources have been used in the creation of media programming in the past, they have been typically used in the context of either a substantial involvement of skilled professionals such as announcers, editors, and engineers, or in ways limited by the necessity of utilizing and repeating large programming segments.

The method of the present invention substantially reduces (in some cases to zero) the need for such skilled professional intervention, once a suitable number of pre-recorded segments have been created, and by permitting the generation of programming from smaller elements, enables the generation of a greater variety of programming from a given amount of pre-recorded material. Nothing of the sort now exists.

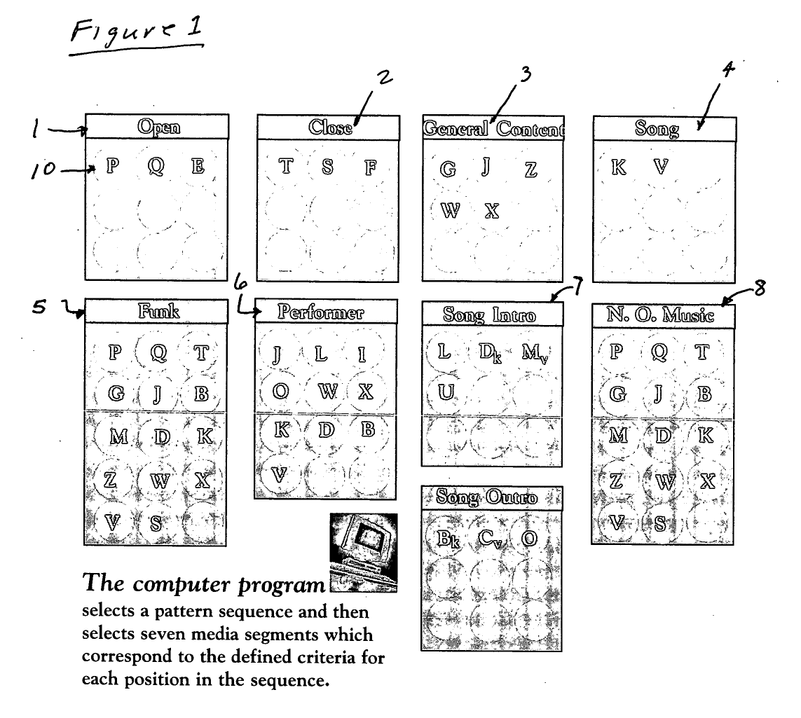

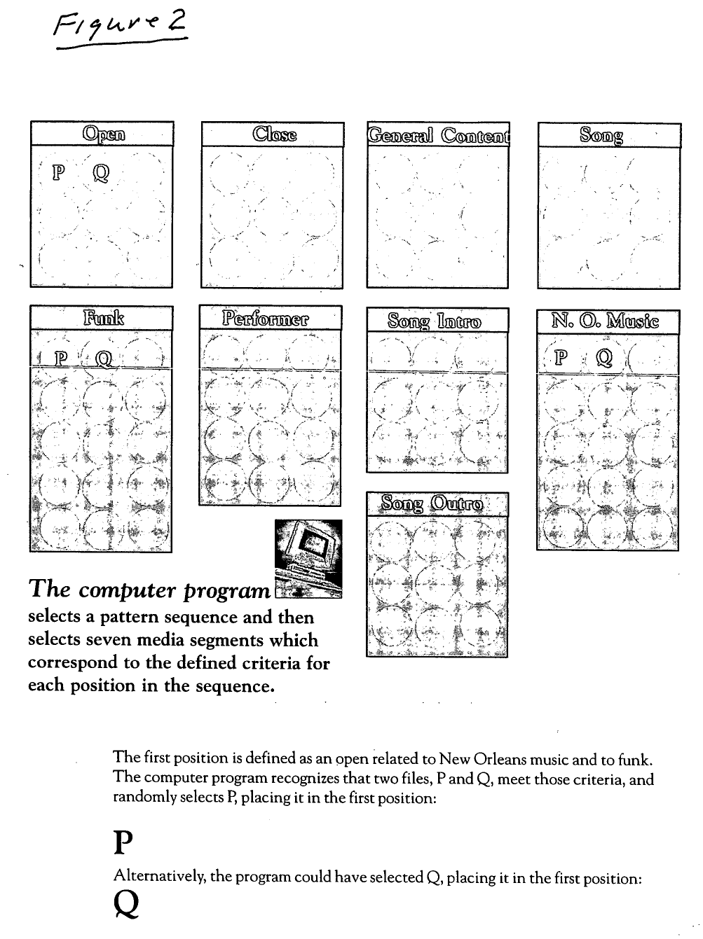

A simplified diagram of the method of the present invention is illustrated in FIG. 1 and can be used to illustrate the method. FIG. 1 assumes that audio segments have been created, all of which are identified as related to New Orleans music as indicated by reference number 8, and some of which are identified as related to a genre of New Orleans music known as “funk” as indicated by reference number 5. These segments will be assembled by a computer automated process into a programming sequence suitable for inclusion in a radio show.

Some of the segments are identified as “opens”, as indicated by reference number 1, meaning that they can introduce a sequence. Others are identified as “closes”, as indicated by reference number 2, meaning that they can end a sequence. Still others are identified as “general content”, as indicated by reference number 3, meaning they can be used in other locations but not to open or close a sequence. Some of those segments are identified with a specific performer as indicated by reference number 6. Some are identified with a particular song as indicated by reference number 4. Some are song introductions, as indicated by reference number 7. Some are song “outros”, as indicated by reference number 9, which refer back to an already played song.

Each media segment (in this case audio segments) in FIG. 1 is represented by a circle 10 for each segment. Each media segment carries a unique identifier (in an actual database that identifier can, for example, a complex alpha-numeric sequence with millions of possible combinations. The simplified diagram in FIG. 1, the unique identifier is a letter of the alphabet placed within circles 10.

When a particular media segment, designated by a circle with a letter, is found inside a box, that significs that in the database it would be identified with the characteristic designated by the title on that box. Thus when a media segment, represented by a circle containing a letter, appears in the box labeled “Open,” it signifies that in an actual database that segment would be identified as eligible to be used in an opening position.

If, however, the sequence patterns specifies that a segment must be an open which is about New Orleans music, only a segment which in FIG. 1 also appears in the box labeled New Orleans music, signifying that in the database it would also be identified with that characteristic, would be eligible, and so on for each of the characteristics described. In an actual database there might be hundreds of such characteristics, but in this simplified diagram of FIG. 1 there are only nine for purposes of illustration.

A computer program has been created which includes multiple sequence patterns based on the formulaic character of the genre of programming being created.

In the present invention, a computer program selects one such sequence pattern, in this case requiring seven media segments. In the example illustrated in FIG. 1, that pattern sequence is as follows:

First Position: An open segment related to New Orleans music and to funk.

Second Position: A general content segment related to New Orleans music and to funk.

Third Position: A general content segment related to New Orleans music, to funk, and to a particular artist.

Fourth Position: A segment introducing a song recorded by that artist.

Fifth Position: The referenced song recorded by that artist

Sixth Position: A segment containing an “outro” reference to the song just played

Seventh Position: A segment related to New Orleans music, funk, and designated as a close.

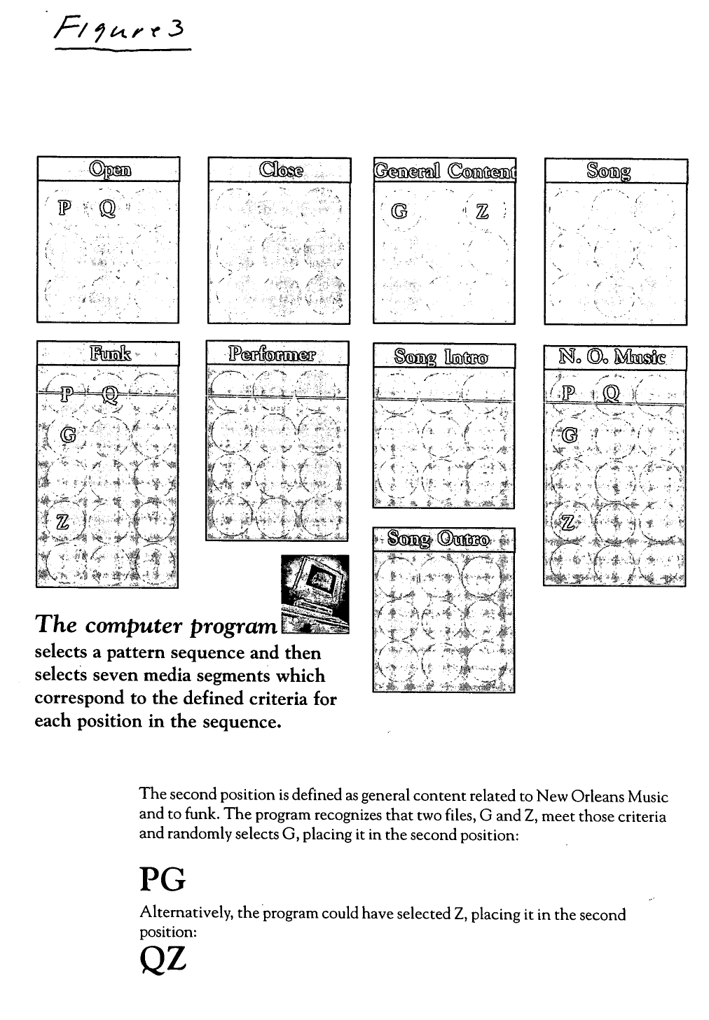

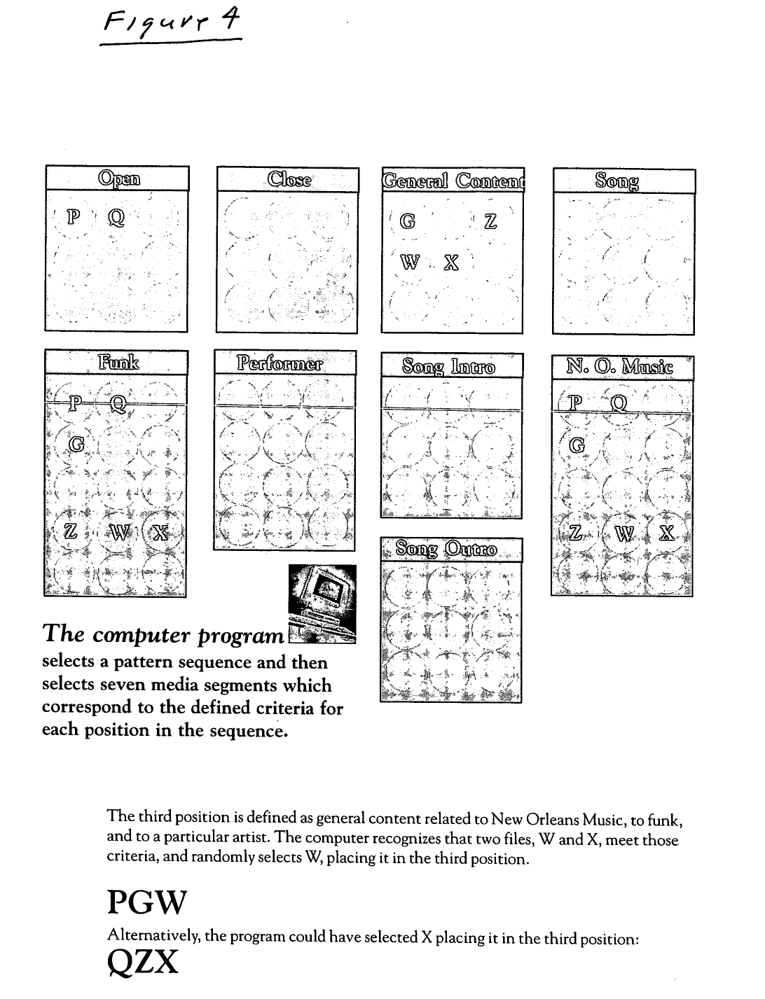

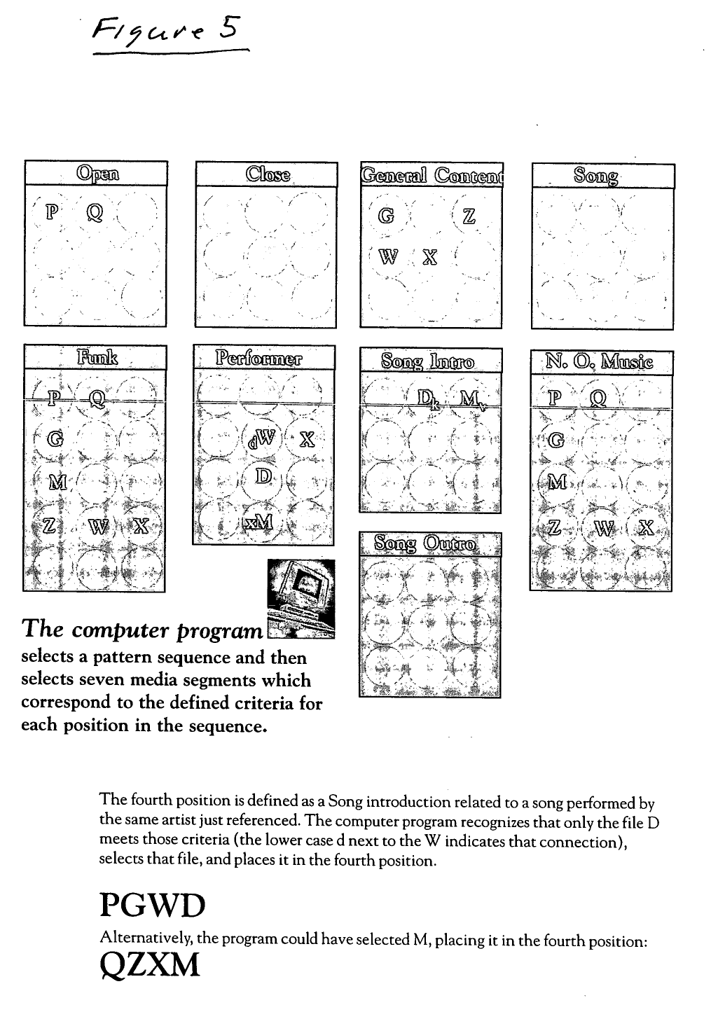

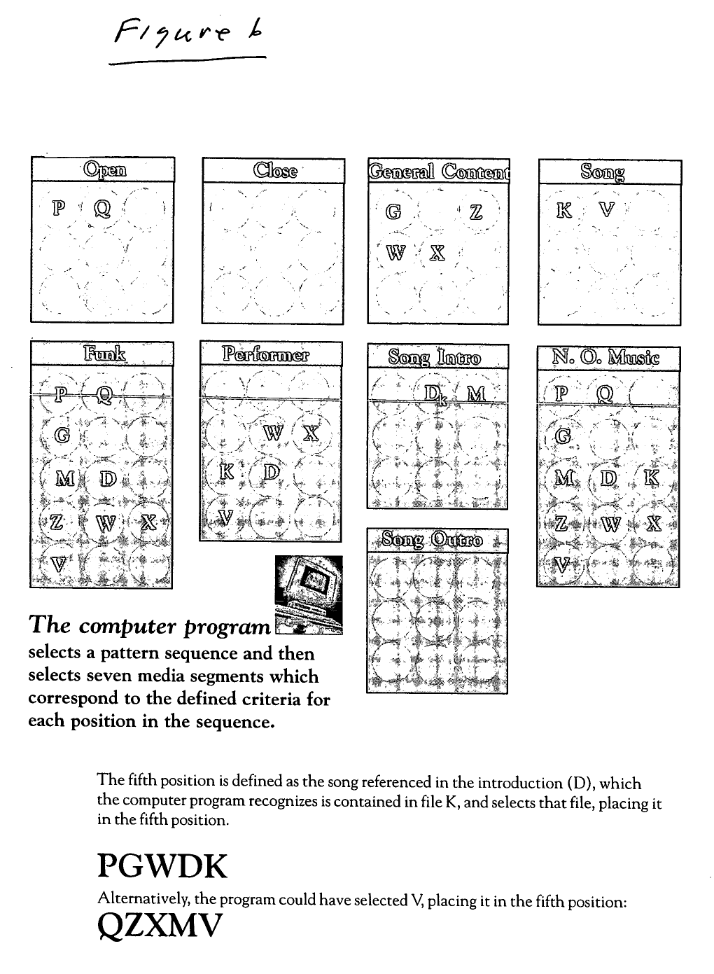

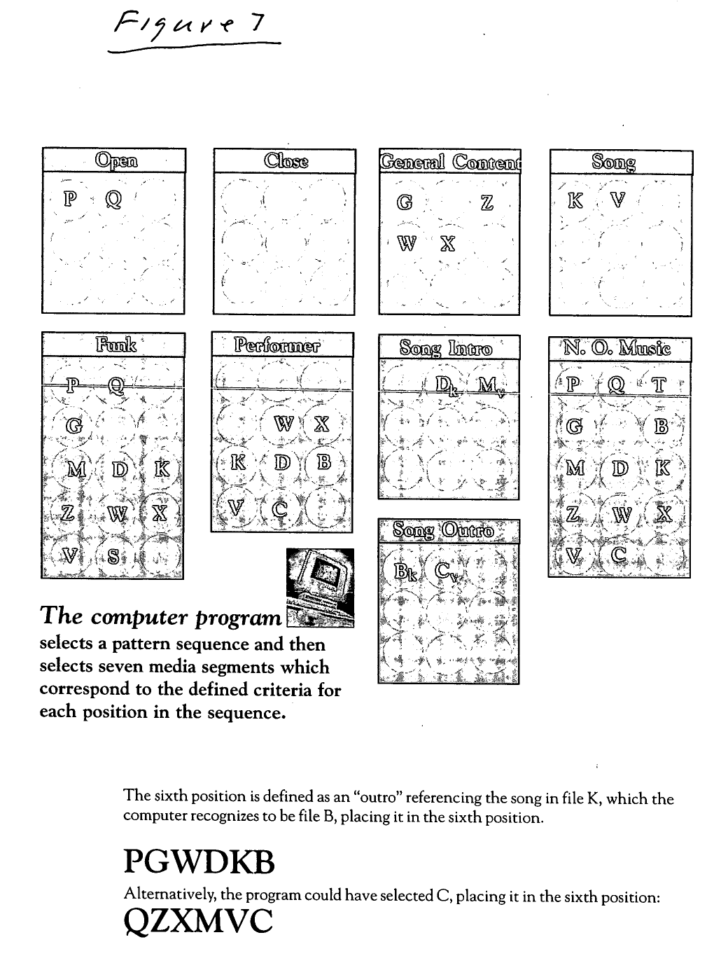

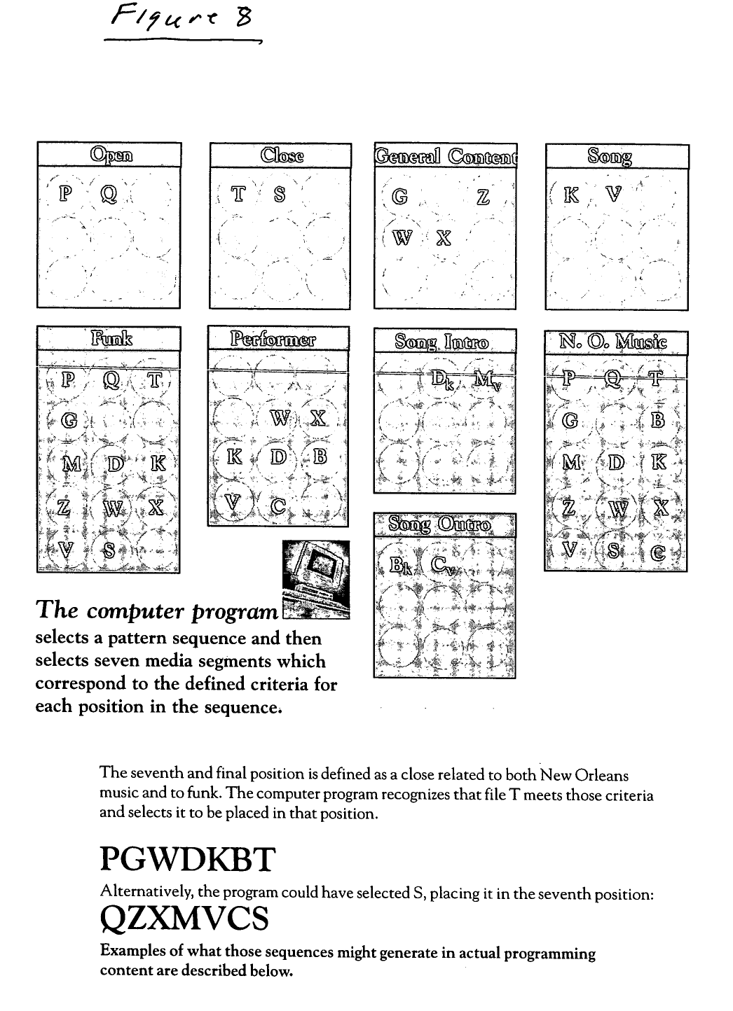

FIGS. 1 to 8 illustrate how the computer program would generate a composite media file corresponding to such a pattern sequence.

This might produce a recorded script such as follows:
“Funk is hard to define but most of us know it when we hear it. It's not really hard to understand what Lee Dorsey meant when he recorded his classic, ‘Everything I do's gonna be funky from now on.’” (An open segment related to New Orleans music and to funk).

“The term funk has been around New Orleans for a long time. Back in the 1890's the great trumpet player Buddy Bolden—he was the one the old musicians said first played “the big noise,” as old timers called early jazz—used to play at the Union Sons Hall on Perdido Street. Sometimes the crowded space would get a little stuffy. One night the band improvised a song around some joking lyrics:‘I think I heard Buddy Bolden say, Funky Butt, Funky Butt, take it away.’ People started calling the Sons of Union Hall Funky Butt Hall. So funk music was born right here in New Orleans, more than a hundred years ago.” (A general content segment related to New Orleans music and to funk).
Maybe as much as any performer, the great Dr. John, Mac Rebbenac, might be thought of as the essence of funk. (A general content segment related to New Orleans music, to funk, and to a particular artist).
“Here's Dr. John playing and singing the universal lament:‘I had the right place, must have been the wrong time.’ Take it away, Mac.” (An introduction to a song by that artist).
   The song plays.

“That was Dr. John on the right train, but in the wrong car, and it's been wrong, wrong, wrong, so long.” (An “outro” referring back to the song).
“We're going to a break here, but we'll have more music and we'll still be funky when we come back.” (A closing segment related to New Orleans music and to funk).

On another occasion, using the same database of media segments and the same rules of combination, the computer program might generate a different script. The rules of combination might include a prohibition against repeating an already-used media segment in close proximity to its earlier occurrence. This time the script created might look as follows:
“Is your apartment a little funky? That might be a bad thing. Is your soul a little funky? That might be a good thing. And for sure when you are in New Orleans, and the music gets funky, that is a very good thing. We're here, we're funky, and we'll be here all night. And as Barbara Shorts likes to say, in New Orleans if its all night it's all right.” (An open related to New Orleans music and to funk).
“On Rampart street in New Orleans there's a location that once was a beautiful Art Deco restaurant. It closed down, and it sat for several years, and, well it got kind of funky in there. So when some guys decided to open a music club there, and they didn't have the money to renovate it, they decided to name it Funky Butt Hall.” (A general content segment related to New Orleans music and to funk).
“Have you ever been to a Neville Brothers concert? If you have, you know just why they are sometimes called the Kings of Funk”. (A segment related to New Orleans music, to funk, and to a particular artist.
“Here they are with one of their defining songs, from the album with the same title:‘Fiyo on the Bayou’. Watch out or they'll set your heart on fiyo.”

(Intro to a song by that artist,)

The song plays.

“Isn't Aaron Neville's voice incredible? And have you ever seen him? What a good looking guy. You just heard him and his whole family on Fiyo on the Bayou.” (An outro referring back to the song.”
“Who do you think is the funkiest piano player in New Orleans? Dr. John? John Cleary? James Booker? Eddi Bo? Davell Crawford? A.J. Loria? If you keep listening, sooner or later you may find out. And for sure you know that I am the funkiest DJ in New Orleans, or in the universe for that matter.” (A closing segment related to New Orleans music and to funk).

Identical in their formulaic structure, these two sequences repeat only in the fact that both mention Funky Butt Hall. Yet they can be computer generated using the same store of media segments and the same rules of combination. With a suitable variety of “formulas” for combining segments, almost unlimited fresh programming can be generated from a limited number of media segments. The method works in essentially the same way for any medium or genre of programming, using the formulaic structure of the genre to create, organize, and combine media segments.

The present invention has been described with reference to a preferred embodiment. However, it is to be understood by those skilled in the art that the invention is not limited thereto. Accordingly, the scope of the present invention is to be established by the claims appended hereto.

1. A computerized method for generating from a limited number of media clips a wide variety of media programming, said method comprising the steps of:
preparing said media clips;
storing said media clips on a digital platform;
combining said media clips into programming into sequences suitable for delivery by broadcast to an audience.
